(19) United States
(12) Patent Application Publication
(10) Pub. No.: US 2025/0276629 A1
(43) Pub. Date: Sep. 4, 2025

(54) VEHICLE REAR GATE WITH INTEGRATED PANEL

(71) Applicant: Rivian IP Holdings, LLC, Irvine, CA (US)

(72) Inventors: Jonathan James SZCZUPAK, Laguna Niguel, CA (US); Mohamad Jeffery HAMMOUD, Bloomfield Hills, MI (US); Robert SCARINGE, Bloomington, IL (US); Ryan Patrick JOYCE, Long Beach, CA (US); Mark Lennard TAYLOR, Laguna Beach, CA (US); Jennifer STERLING, Ladera Ranch, CA (US); Praxedis Del Carmen CAMACHO RAMIREZ, Laguna Niguel, CA (US); Matthew Mark ZOLLER, Marina Del Rey, CA (US); James John Alexander DOWLE, Laguna Beach, CA (US)

(21) Appl. No.: 19/049,786

(22) Filed: Feb. 10, 2025

Related U.S. Application Data
(60) Provisional application No. 63/560,589, filed on Mar. 1, 2024.

(51) Int. Cl. B60N 3/00

(52) U.S. Cl. CPC B60N 3/002

(57) ABSTRACT

A vehicle includes a panel integrated with a gate. The panel is designed to move relative to the gate and provide a space (e.g., workstation) for passengers or users to place their belongings. The panel may be stored in the gate when not in use. Further, the panel may be opened and closed using brackets that facilitate both linear and rotational movement of the panel. Alternatively, the panel may be opened and closed using hinge assemblies that facilitate rotational movement of the panel.

### CROSS REFERENCE TO RELATED APPLICATION(S)

The present application claims the benefit of U.S. Provisional Application No. 63/560,589 entitled “VEHICLE REAR GATE WITH INTEGRATED PANEL”, filed Mar. 1, 2024, the entirety of which is incorporated herein for reference.

### INTRODUCTION

This application is directed to vehicles, and more particularly, to vehicles with gates with a built-in movable panel.

### SUMMARY

Vehicles may include a gate designed to move from a closed position to an open position, or vice versa, based upon a desired use. For example, a gate, in the closed position, encloses objects or cargo inside the vehicle. Gates described herein may further include a panel that may be deployed from the gate, thereby providing an area for users to place items (e.g., computing devices, work-related items, personal items, etc.).

Vehicles may include a gate designed to move from a closed position to an open position, or vice versa, based upon a desired use. For example, a gate, in the closed position, encloses objects or cargo inside the vehicle. Gates described herein may further include a panel that may be deployed from the gate, thereby providing an area for users to place items (e.g., computing devices, work-related items, personal items, etc.).

In one or more aspects of the present disclosure, an apparatus is described. The apparatus may include a panel configured to provide a receiving surface for one or more objects. The apparatus may further include a carrier including a recess configured to receive the panel in a first position, the carrier including a guide. The apparatus may further include a bracket coupled to the panel. The bracket may be configured to move along the guide and transition the panel to a second position different from the first position. In the second position, the panel may be removed from the recess. In the second position, the panel may be rotated relative to the carrier. In the second position, the panel may be perpendicular with respect to the carrier.

The carrier may be configured to secure within a gate body of a vehicle, the panel, in the first position, may be stowed in the gate body, and the panel, in the second position, may be deployed from the gate body. The panel, in the second position, may provide the receiving surface.

The apparatus may further include a bushing coupled with the panel. The carrier may include a rail, and the bushing may be located in the rail. The bushing may be configured to move with the panel. The panel may be configured to rotate from the first position to the second position based on the bushing.

In one or more aspects of the present disclosure, a gate for a vehicle is described. The gate may include a gate body including an opening. The gate may further include a carrier coupled with the gate body and positioned in the opening. The carrier may include a rail. The gate may further include a bushing located in the rail. The gate may further include a panel coupled with the bushing. In a first position, the panel may be positioned in the opening, and in a second position, the panel may be moved out the carrier and the opening and rotated relative to the gate body.

The bushing may be configured to move along the rail, and the panel may be configured to rotate relative to the bushing. The gate body may include an edge, and the panel, in the second position, may be flush with the edge.

The gate may further include an enclosure. The enclosure may be configured to: occupy an opening of the gate body, and may be further configured to move relative to the opening and into the gate body. The enclosure may include glass. The panel, in the second position, may provide a receiving surface for one or more objects. The carrier may include a recess, and the panel, in the first position, may be positioned in the recess.

In one or more aspects of the present disclosure, a vehicle is described. The vehicle may include a vehicle body that defines a cabin. The vehicle may further include a gate configured to move relative to the vehicle body. The gate may include a gate body including an opening. The gate may further include a carrier coupled with the gate body and positioned in the opening, the carrier including a rail. The gate may further include a bushing located in the rail. The gate may further include a panel coupled with the bushing. In a first position, the panel may be positioned in the opening, and in a second position, the panel may be moved out the carrier and the opening and rotated relative to the gate body.

The panel, in the second position, may extend into the cabin. The bushing may be configured to move along the rail, and the panel may be configured to rotate relative to the bushing. The gate body may include an edge, and the panel, in the second position, may be flush with the edge.

In one or more aspects of the present disclosure, a panel for a gate of a vehicle is described.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of an example of a vehicle, in accordance with one or more aspects of the present disclosure.

FIG. 2 illustrates a side view of an alternate example of a vehicle, in accordance with one or more aspects of the present disclosure.

FIG. 3A illustrates a rear view of a vehicle, showing a gate of the vehicle in a closed position, in accordance with one or more aspects of the present disclosure.

FIG. 3B illustrates a rear view of a vehicle, showing a gate of the vehicle in an open position, in accordance with one or more aspects of the present disclosure.

FIG. 4 illustrates a perspective view of an example of a gate, in accordance with one or more aspects of the present disclosure.

FIG. 5 illustrates a perspective view of the gate, showing the panel positioned within the gate, in accordance with one or more aspects of the present disclosure.

FIG. 6 illustrates an alternate perspective view of the gate, showing additional features of the carrier, in accordance with one or more aspects of the present disclosure.

FIG. 7 illustrates an enlarged perspective view of a panel and a carrier, showing a bushing positioned in a rail of the carrier, in accordance with one or more aspects of the present disclosure.

FIG. 8A and FIG. 8B illustrate perspective views of a panel moving relative to a gate, in accordance with one or more aspects of the present disclosure.

FIG. 9 illustrates a perspective view of an alternate example of a gate, in accordance with one or more aspects of the present disclosure.

FIG. 10A and FIG. 10B illustrate interior views of a vehicle, in accordance with one or more aspects of the present disclosure.

FIG. 11A, FIG. 11B, FIG. 11C, FIG. 11D, FIG. 11E, and FIG. 11F illustrate side views of a hinge assembly and a panel, in accordance with one or more aspects of the present disclosure.

FIG. 12 illustrates an alternate perspective view of a hinge assembly, showing additional features of the hinge assembly, in accordance with one or more aspects of the present disclosure.

FIG. 13 illustrates a side view of an alternate example of a vehicle, showing an enclosure in an open position, in accordance with one or more aspects of the present disclosure.

FIG. 14 illustrates a block diagram of a vehicle, in accordance with one or more aspects of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to gates (e.g., liftgates) for vehicles that include a panel designed to move (e.g., rotate) away from the gate and provide space that may be utilized as a workstation, staging area, or the like. Accordingly, the panel may function as a table or desk for passengers of the vehicle. When not in use, the panel is stowed inside the gate and does not extend into the cabin of the vehicle. When deployed from the gate, the panel provides a horizontal receiving surface for various items. In this regard, the panel may couple with the gate by components such as bushings (as non-limiting examples) that facilitate both linear and rotational movement of the panel.

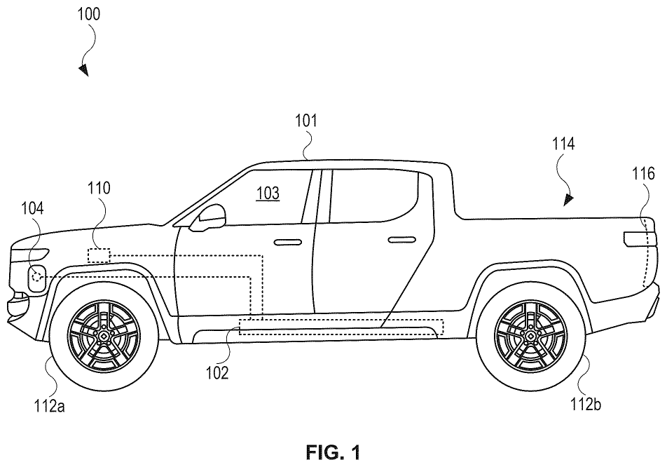

FIG. 1 illustrates an example of a vehicle 100, in accordance with one or more aspects of the present disclosure. In the example shown in FIG. 1, the vehicle 100 takes the form of a truck. Generally, the vehicle 100 may take the form of any motorized vehicle, including motorized vehicles with an internal combustion engine and/or one or more electric motors. Accordingly, other implementations of the vehicle 100 may include land-based vehicles, such as a car (e.g., sedan, hatchback), a van, or a commercial truck, as non-limiting examples.

The vehicle 100 may include a battery pack 102. The battery pack 102 may be carried by a vehicle body 101 of the vehicle 100, with the vehicle body 101 defining a cabin 103 that provides a space for passengers. The battery pack 102 may be coupled (e.g., electrically coupled) to one or more electrical systems of the vehicle 100 to provide power to the one or more electrical systems. For example, the vehicle 100 may include a port 104 (e.g., charge port) designed to receive a cable connector (not shown in FIG. 1) used to transmit power (e.g., alternating current (AC) power) that is converted to direct current (DC) power to charge the battery pack 102. As another exemplary electrical system, the vehicle 100 may include a drive unit 110, representative of one or more additional drive units of the vehicle 100. The battery pack 102 may couple to a drive unit 110. While the drive unit 110 is shown as generally being in the front of the vehicle 100, the drive unit 110 may be located in the rear of the vehicle 100. Further, when multiple drive units are used, at least one drive unit may be in the front of the vehicle 100 to drive the front wheels (e.g., wheel 112a), and at least one drive unit may be in the rear of the vehicle 100 to drive the rear wheels (e.g., wheel 112b). The drive unit 110 may include, for example, a motor, an inverter, a gear box, and a differential. In the example shown in FIG. 1, the drive unit 110 takes the form of an electric motor. In this regard, the drive unit 110 may use energy (e.g., electrical energy) stored in the battery pack 102 for propulsion in order to drive (e.g., rotationally drive) wheels of the vehicle 100.

The vehicle 100 may further include a bed 114 that may be used as a storage area for the vehicle 100. In order to access the bed 114, the vehicle 100 may further include a gate 116. Based on its position on the vehicle 100, the gate 116 may take the form of a closure, such as a rear gate or a tailgate. The gate 116 is designed to open, via rotation, thereby allowing further access to the bed 114.

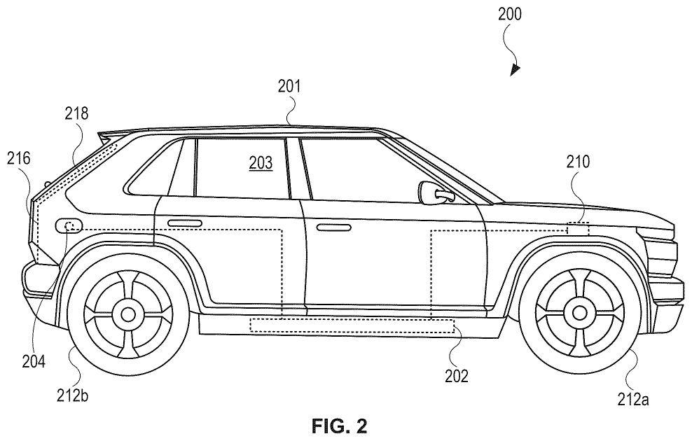

FIG. 2 illustrates a side view of an alternate example of a vehicle 200, in accordance with one or more aspects of the present disclosure. As shown, the vehicle 200 takes the form of a sport utility vehicle (SUV). The vehicle 200 may include several features shown and/or described for the vehicle 100 (shown in FIG. 1). For example, the vehicle 200 may include a vehicle body 201, a battery pack 202, a cabin 203, a port 204 (e.g., charge port), a drive unit 210 (representative of one or more additional drive units), a wheel 212a (representative of an additional front wheel), and a wheel 212b (representative of an additional rear wheel).

The cabin 203 of the vehicle 200 may extend to a rear portion of the vehicle 200. In order to access the rear portion of the cabin 203, the vehicle 200 may further include a gate 216. Based on its position on the vehicle 200, the gate 216 may take the form of a rear gate or a liftgate. The gate 216 is designed to open, via rotation, thereby allowing access to the cabin 203. Additionally, the vehicle 200 may include an enclosure 218. In one or more implementations, the enclosure 218 takes the form of a glass panel. Similar to the gate 216, the enclosure 218 is designed to open, via rotation, thereby allowing further access to the cabin 203.

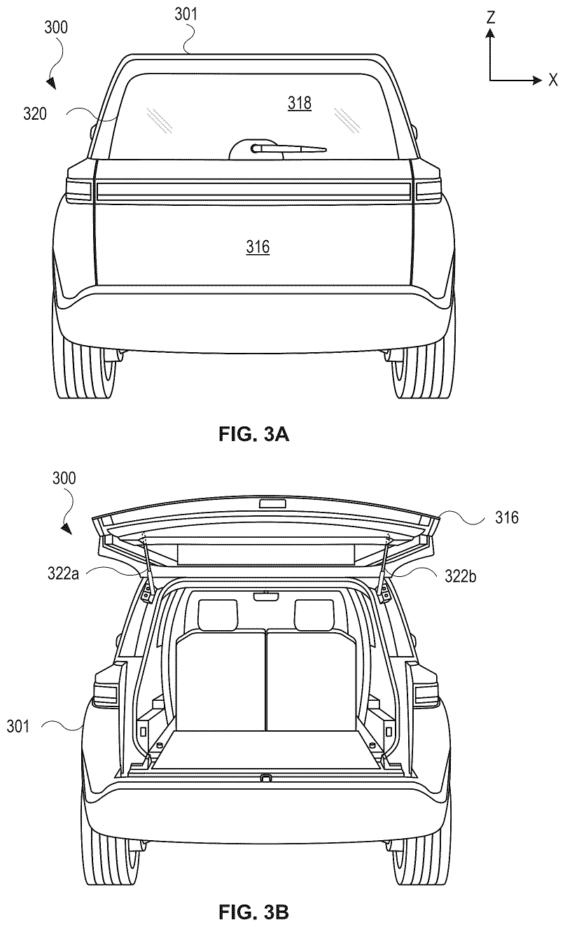

FIG. 3A illustrates a rear view of the vehicle 300, showing a gate 316 of the vehicle 300 in a closed position, in accordance with one or more aspects of the present disclosure. In the example shown in FIG. 3, the vehicle 300 takes the form of an SUV that includes a vehicle body 301. The gate 316 may couple (e.g., rotationally couple) with the vehicle body 301. As shown, the vehicle 300 includes an enclosure 318 carried by the gate 316. The gate 316 includes an opening 320 and the enclosure 318 occupies the opening 320. In one or more implementations, the enclosure 318 takes the form of a glass panel (or other transparent material) designed to move vertically relative to the gate 316. In this regard, the enclosure 318 may be actuated (e.g., by one or more motors) into the gate 316 (e.g., lowered in the Z-direction of Cartesian coordinates), thus allowing user access into the vehicle 300 through the opening 320.

FIG. 3B illustrates a rear view of the vehicle 300, showing the gate 316 in an open position, in accordance with one or more aspects of the present disclosure. As shown, the gate 316 is movable relative to the vehicle body 301. In order to open the gate 316, the vehicle 300 may include a strut 322a and a strut 322b. Each of the struts 322a and 322b may be coupled (e.g., fastened, secured, adhered, or the like) to the gate 316. In one or more implementations, each of the struts 322a and 322b takes the form of a power strut or motorized strut. In this regard, each of the struts 322a and 322b may be operated by, for example, a motor (e.g., electric motor).

Referring to FIG. 3A and FIG. 3B, the enclosure 318 may be opened and closed by automated means. In this regard, the struts 322a and 322b may be operated by a user from a remote location, such as when the user is a driver or passenger sitting in the vehicle 300 or by using a software application (e.g., app) running on a mobile wireless communication device (e.g., smartphone). Beneficially, movement of the enclosure 318 may be controlled by a user without manually grasping or otherwise contacting the enclosure 318. Additionally, the gate 316 may be automatically opened and closed by similar means.

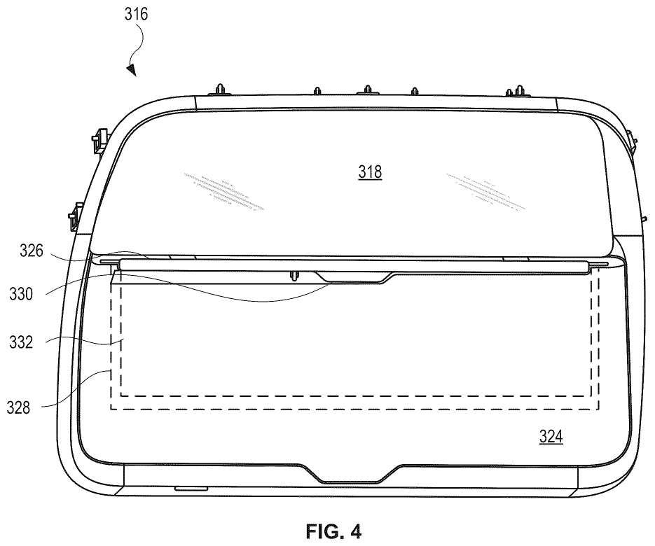

FIG. 4 illustrates a perspective view of the gate 316, in accordance with one or more aspects of the present disclosure. The gate 316 may include a gate body 324 that carries components, such as the enclosure 318. In one or more implementations, the gate body 324 is designed to carry a panel 326. In this regard, the gate body 324 may include an opening 328 and the panel 326 may be stowed in the opening 328, as shown in FIG. 4. However, the panel 326 may be removed from the opening 328 as well. This will be shown and described in further detail below. In order to remove the panel 326, the gate body 324 may include an indentation 330 that provides an area for a user to grasp the panel 326.

The gate body 324 of the gate 316 may include multiple surfaces (e.g., formed body panels), including an interior surface facing a cabin of a vehicle as well as an exterior surface facing an ambient environment external to the vehicle. In a stowed position (shown in FIG. 4), the panel 326 and the carrier 332 are positioned between the interior surface (shown in FIG. 4) and an exterior surface of the gate body 324.

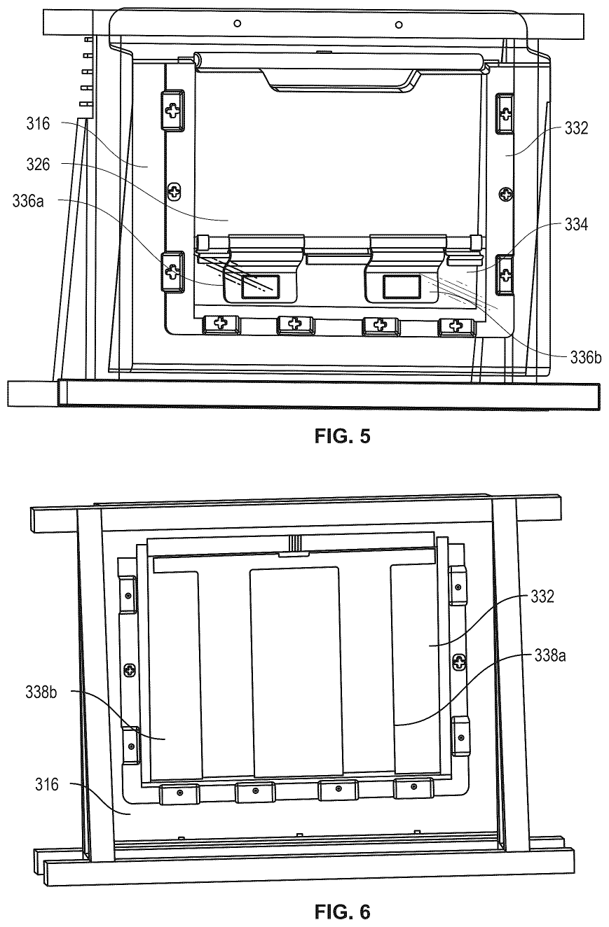

FIG. 5 illustrates a perspective view of the gate 316, showing the panel 326 positioned within the gate 316, in accordance with one or more aspects of the present disclosure. Additional features may be included in the gate 316. For example, the gate 316 may include a carrier 332 designed to hold, or carry, the panel 326. The carrier 332 may include a recess 334 that receives the panel 326 in a stowed position of the panel 326. Also, a bracket 336a and a bracket 336b may couple with the panel 326.

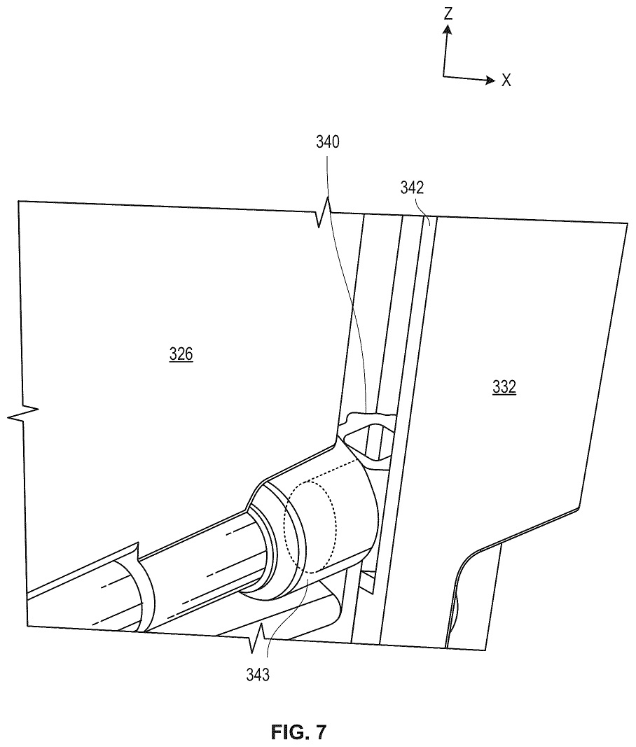

FIG. 6 illustrates an alternate perspective view of the gate 316, showing additional features of the carrier 332, in accordance with one or more aspects of the present disclosure. As shown, the carrier 332 may include a guide 338a and a guide 338b designed to receive the bracket 336a and the bracket 336b, respectively, with the brackets 336a and 336b shown in FIG. 5. The guide 338a and the guide 338b provide a space along which the bracket 336a and the bracket 336b, respectively, may move. This may result in movement of the panel 326 out of the gate 316.

FIG. 7 illustrates an enlarged perspective view of the panel 326 and the carrier 332, showing a bushing 340 positioned in a rail 342 of the carrier 332, in accordance with one or more aspects of the present disclosure. The bushing 340 and the rail 342 may be representative of an additional bushing and an additional rail, respectively. The bushing 340 is designed to move along the rail 342 (e.g., in the Z-direction). As shown, the panel 326 includes a receptacle 343 designed to receive the bushing 340.

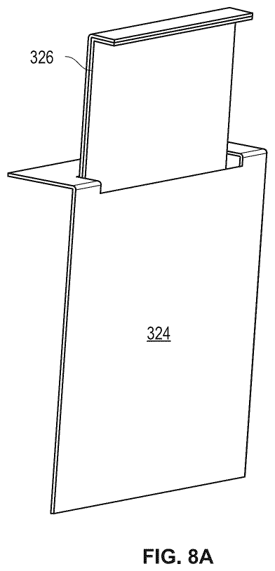

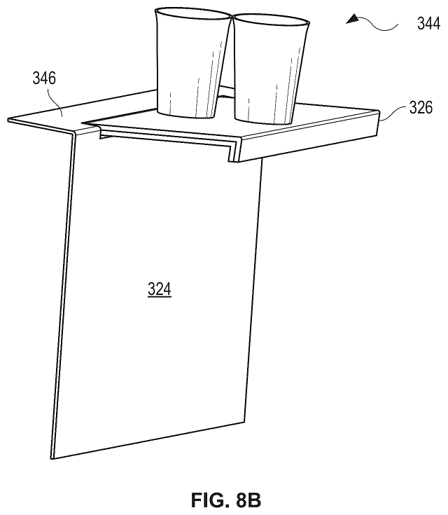

FIG. 8A and FIG. 8B illustrate perspective views of the panel 326 moving relative to a gate 316, in accordance with one or more aspects of the present disclosure. Referring to FIG. 8A, the panel 326 is moved out of the gate body 324. As shown, the panel 326 may move in a direction parallel, or approximately, parallel with respect to the gate body 324. In this regard, the panel 326 may move vertically or in a linear manner. Referring to FIG. 8B, the panel 326 is removed from the gate body 324 and rotated with respect to the gate body 324, thus providing a receiving surface for objects 344. As shown in FIG. 8B, the gate body 324 may include an edge 346, and the panel 326 may be flush, or co-planar, with respect to the edge 346. Also, the panel 326 may be perpendicular, or substantially perpendicular, with respect to the gate body 324.

Referring again to FIG. 5, FIG. 6, and FIG. 7, the panel 326 is in a stowed position, in which the panel 326 is positioned in the gate 316, including the gate body 324 (shown in FIG. 4). When the panel 326 is being removed from the gate 316, the bushing 340 (shown in FIG. 7) may move along the rail 342 (shown in FIG. 7). Additionally, each of the brackets 336a and 336b may function as a hinge. In this regard, when moved out of the carrier 332 (shown in FIG. 5), the panel 326 may rotate relative to the gate body 324 and transition to a deployed position, thus providing a horizontal, or substantially horizontal, receiving surface. The panel 326, the carrier 332, the brackets 336a and 336b, and the bushing 340 may be assembled as an apparatus for vehicles shown and/or described herein.

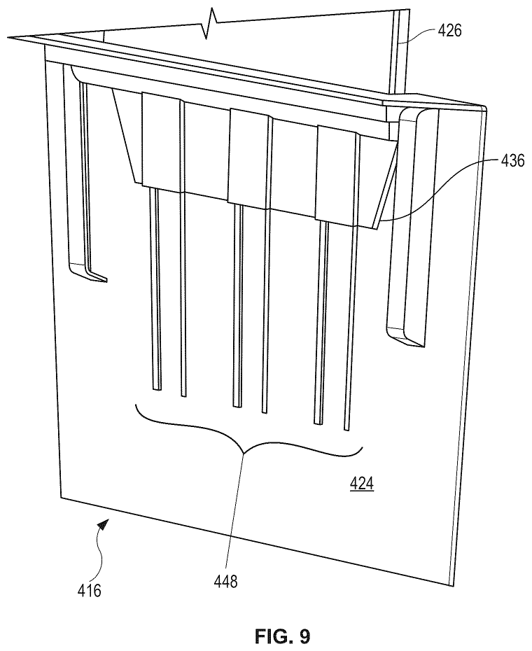

FIG. 9 illustrates a perspective view of an alternate example of a gate 416, in accordance with one or more aspects of the present disclosure. The gate 416 may include a gate body 424 and a panel 426. The panel 426 may be coupled with a bracket 436. The gate body 424 may grooves 448. The grooves 448 may provide a track along which the bracket 436 may move. In this regard, the panel 426 may move with the bracket 436. Further, the bracket 436 may function as a hinge, thus allowing the panel 426 to rotate with respect to the gate body 424.

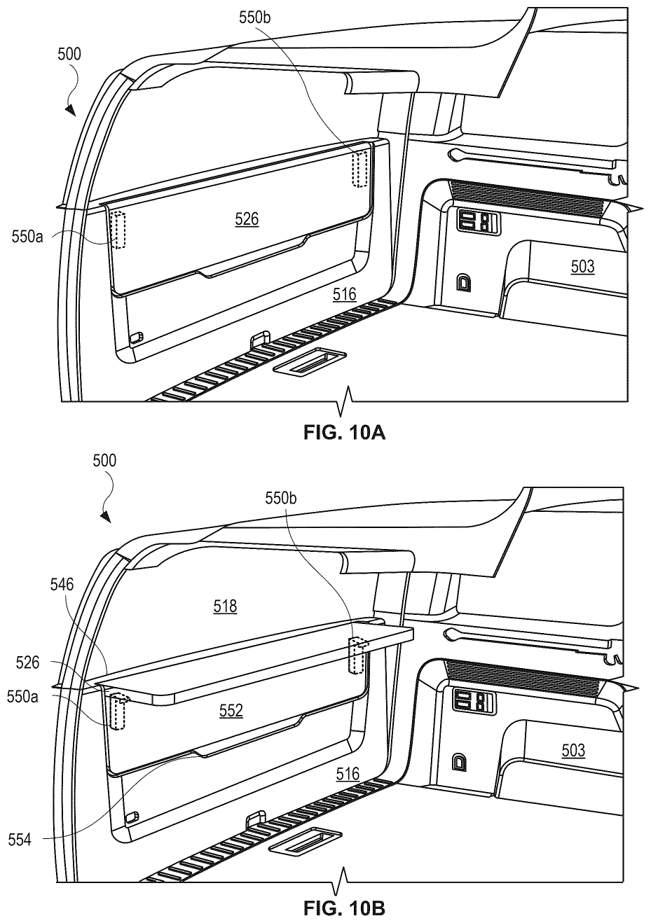

FIG. 10A and FIG. 10B illustrate interior views of a vehicle 500, in accordance with one or more aspects of the present disclosure. In particular, a cabin 503 of the vehicle 500 is shown. Referring to FIG. 10A, the vehicle 500 includes a panel 526 integrated with the gate 516 (defining a gate body). As shown, the panel 526 is in a closed position, or stowed position, and is stored in the gate 516. The panel 526 is designed to move relative to the gate 516 when, for example, the gate 516 is in a closed position as shown in FIG. 10A. In this regard, the vehicle 500 may include a hinge assembly 550a and a hinge assembly 550b, each of which may be used to move the panel 526.

Referring to FIG. 10B, the panel 526 is transitioned to an open position, or deployed position. In this regard, the panel 526 moves relative to the gate 516 and out of a recess 552 formed in the gate 516. Each of the hinge assemblies 550a and 550b may include one or more movable arms to facilitate moving the panel 526. Also, each of the hinge assemblies 550a and 550b may be hidden, or at least substantially hidden, from view from passengers or users. In this regard, the panel 526 and/or one or more interior features in the vehicle 500 (e.g., in the cabin 503) may cover, or otherwise obscure, the hinge assemblies 550a and 550b from view. This may not only enhance the overall aesthetics of the cabin 503, but also prevent passengers or users from inadvertently contacting either or both of the hinge assemblies 550a and 550b. In one or more implementations, each of the hinge assemblies 550a and 550b takes to form of a motorized hinge that may be operated or controlled remotely. As a result, the panel 526 may be moved by automated means. Additionally or alternatively, the panel 526 may be moved by manual means. For example, the gate 516 may further include an indentation 554 extending from the recess 552, with the indentation 554 providing an area by which a passenger can grasp and move the panel 526.

In the open position, the panel 526 extends, or is moved, into the cabin 503. Also, when the panel 526 is in the open position, the panel 526 may be flush, or co-planar, with respect to an edge 546 of the gate 516. Beneficially, the panel 526, in the open position, forms a table that can be used as a workstation, staging area, etc. Further, the vehicle 500 may include an enclosure 518, or glass structure. As shown, the enclosure 518 is in a closed positioned, and passengers within the cabin 503 may utilize the panel 526. However, the enclosure 518 may transition to an open position, where the enclosure 518 is positioned in the gate 516 (e.g., the enclosure 518 occupies an opening of the gate body of the gate 516), thus allowing users outside the vehicle 500 to access and utilize the panel 526.

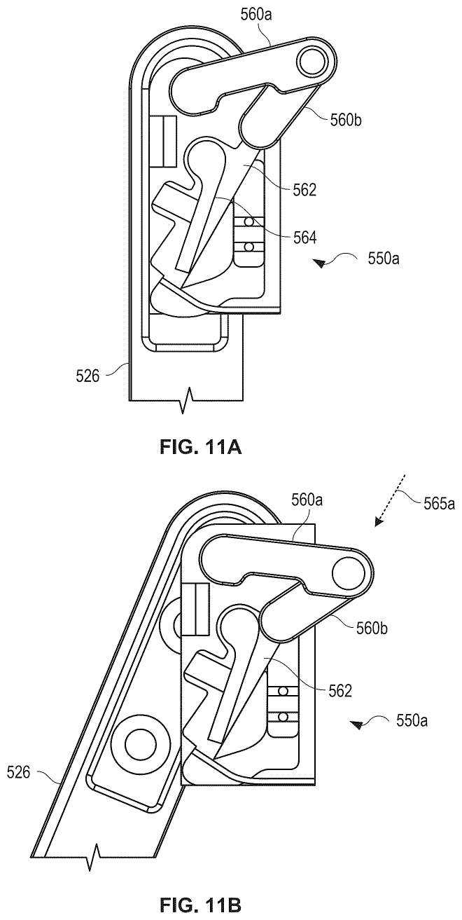

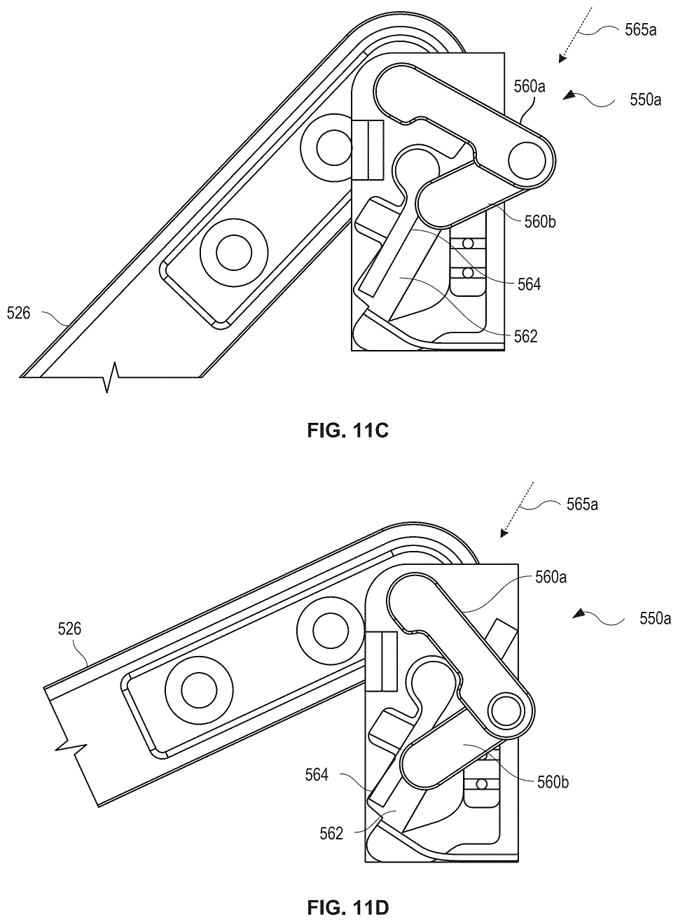

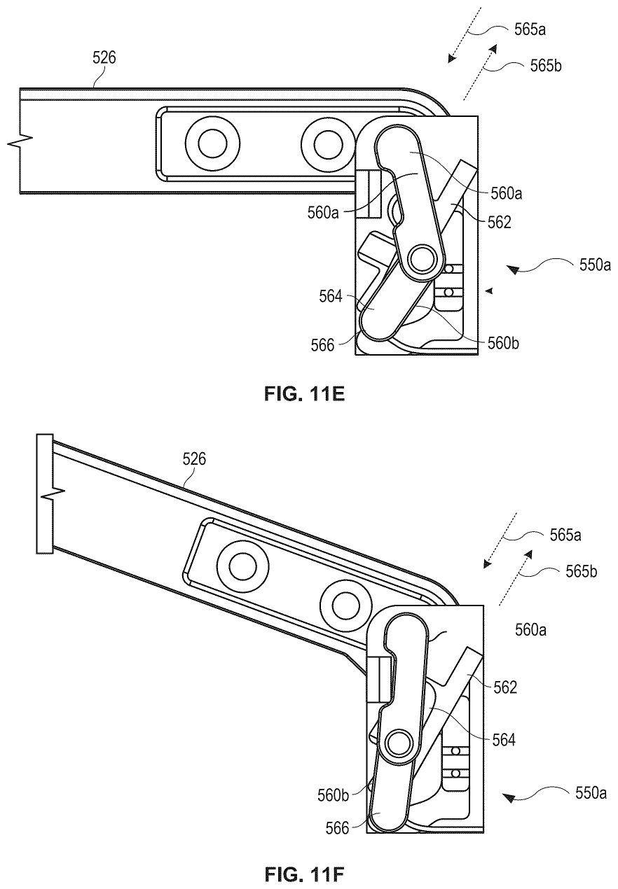

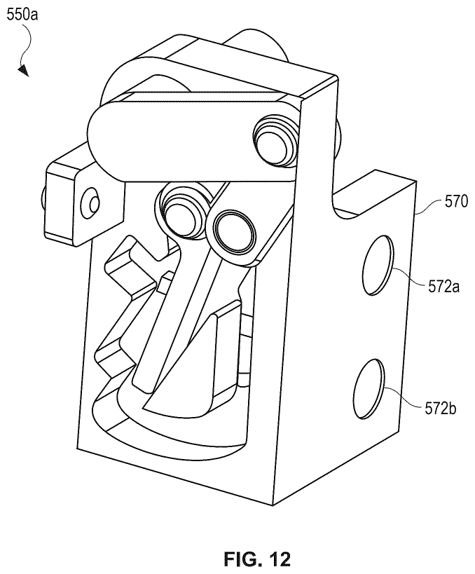

FIG. 11A, FIG. 11B, FIG. 11C, FIG. 11D, FIG. 11E, and FIG. 11F illustrate side views of the hinge assembly 550a and a panel 526, in accordance with one or more aspects of the present disclosure. The hinge assembly 550a may be representative of the hinge assembly 550b (shown in FIGS. 10A and 10B), and accordingly, the hinge assembly 550b may include any features shown and/or described for the hinge assembly 550a.

Referring to FIG. 11A, the hinge assembly 550a positions the panel 526 in a stowed positioned (e.g., in a recess 552 of a gate 516, shown in FIG. 10B). The hinge assembly 550a may include an arm 560a and an arm 560b coupled (e.g., rotationally coupled) with the arm 560a. The arms 560a and 560b may function as levers designed to rotate, thus rotating and moving the panel 526. The hinge assembly 550a may further include a track 562. The arm 560b is positioned, or at least partially positioned by way of a pin (not shown in FIG. 11A), in the track 562. In this regard, the arm 560b is designed to move along the track 562 in either of two directions. The hinge assembly 550a may further include a pin 564. As shown, the pin 564 is positioned, or at least partially positioned, in the track 562. In some instances, the pin 564 may permit movement of the arm 560a along the track 562. Conversely, in other instances, the pin 564 may prevent of the arm 560b from moving along the track 562, thus locking the arm 560b, and in turn the panel 526, in place.

Referring to FIG. 11B, the hinge assembly 550a permits movement of the panel 526. Movement of the panel 526 may be initiated by manual or automated means. As shown, each of the arms 560a and 560b rotate, with the arm 560b moving along the track 562 in a direction of an arrow 565a.

Referring to FIG. 11C, the hinge assembly 550a permits further movement of the panel 526. As shown, each of the arms 560a and 560b rotate, with the arm 560b further moving along the track 562 (in the direction of the arrow 565a) and engaging the pin 564, causing the pin 564 to move (e.g., rotate) out of, or at least further out of, the track 562.

Referring to FIG. 11D, the hinge assembly 550a permits further movement of the panel 526. As shown, each of the arms 560a and 560b rotate, with the arm 560b further moving along the track 562 (in the direction of the arrow 565a) and causing further movement of the pin 564 out of, or at least further out of, the track 562.

Referring to FIG. 11E, the hinge assembly 550a permits further movement of the panel 526. As shown, each of the arms 560a and 560b rotate, with the arm 560b further moving along the track 562 (in the direction of the arrow 565a) and causing further movement of the pin 564. As shown, the arm 560b includes a pin 566. Based on the additional movement of the arm 560b, the pin 566 is moved along the track 562 past the pin 564, causing the pin 564 to move into, or at least further into, the track 562. In this regard, the pin 564 may prevent movement of the arm 560b from returning to a prior position. Put another way, the pin 564 may engage the pin 566 and prevent the arm 560b from moving along the track in a direction of an arrow 565b, with the direction of the arrow 565b being opposite that of the arrow 565a. As shown, the pin 564 is positioned over, and engaged with, the pin 566 in a manner such that the pin 566, and in turn, the arm 560b, is prevented from moving along the track 562 in the direction of the arrow 565b. Based in part on the weight of the panel 526, the pins 564 and 566 remain engaged with each other. As a result, the panel 526 remains fixed in a deployed position as shown in FIG. 11E.

Referring to FIG. 11F, in order to return the panel 526 from the deployed position (shown in FIG. 11E) to the stowed position (shown in FIG. 11A), the panel 526 may be further moved (e.g., lifted) to a position above a horizontal axis. By moving the panel 526 in the manner shown in FIG. 11F, the arm 560b may further move along the track 562 in a direction of the arrow 565a, causing the pins 564 and 566 to disengage. The pin 564 may out of the track 562, or at least partially out of the track 562, allowing the arm 560b to move in a direction of the arrow 565b. Accordingly, the arms 560b and 560b may rotate, which in turn allows the panel 526 to return to the stowed position.

It should be noted that the aforementioned features (e.g., panel, carrier, etc.) are shown as being integrated with a gate. However, other components of a vehicle (e.g., vehicle door, console, dashboard) may also integrate features, such as the panel, the carrier, etc.

FIG. 12 illustrates an alternate perspective view of the hinge assembly 550a, showing additional features of the hinge assembly 550a, in accordance with one or more aspects of the present disclosure. As shown, the hinge assembly 550a may include a base 570 that includes an opening 572a and an opening 572b, with each of the openings 572a and 572b designed to receive an object such as fastener, a rivet, or the like. Accordingly, using the base 570, the hinge assembly 550a may couple to a vehicle body or a gate.

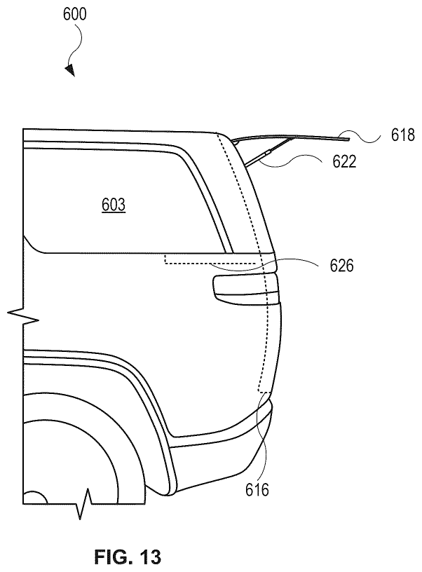

FIG. 13 illustrates a side view of an alternate example of a vehicle 600, showing an enclosure 618 in an open position, in accordance with one or more aspects of the present disclosure. As shown, the vehicle 600 may include a gate 616. The enclosure 618 (e.g., glass panel) may move relative to the gate 616 by, for example, a strut 622 (representative of an additional strut). Also, the gate 616 may include a panel 626 (shown as dotted lines). As shown, the panel 626 is in a deployed position and extends into a cabin 603 of the vehicle 600. However, when the enclosure 618 is in the open position, users outside the vehicle 600 may utilize the panel 626.

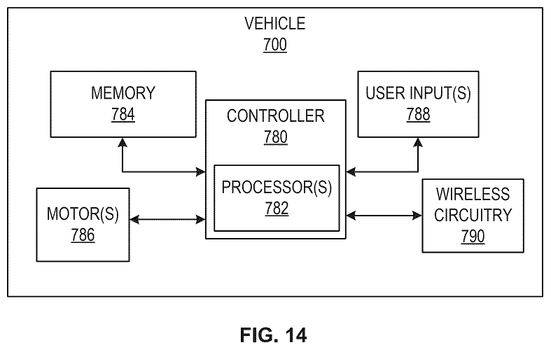

FIG. 14 illustrates a block diagram of a vehicle 700, in accordance with one or more aspects of the present disclosure. As shown, the vehicle 700 may include a controller 780. In one or more implementations, the controller 780 includes one or more processors 782. The one or more processors 782 may include processing circuitry, such as a central processing unit (CPU), a graphics processing unit (GPU), one or more microcontrollers, an application specific integrated circuit (ASIC), or a combination thereof, as non-limiting examples. Additionally, the vehicle 700 may further include memory 784 that stores instructions and/or code, each of which being executable by the one or more processors 782. The memory 784 may include read-only memory (ROM) and/or random access memory (RAM).

The vehicle 700 one or more motors 786. In one or more implementations, at least some of the one or more motors 786 are utilized to actuate one or more brackets (e.g., brackets 336a and 336b, shown in FIG. 5). In this regard, the vehicle 700 may include a panel (e.g., panel 326 shown in FIG. 8B) that may be moved, for example, from a stowed position to a deployed position, or vice versa, by automated means (e.g., through controlling the brackets). Alternatively, at least some of the one or more motors 786 are utilized to actuate one or more hinge assemblies (e.g., hinge assemblies 550a and 550b, shown in FIG. 10A). In this regard, the vehicle 700 may include a panel (e.g., panel 526 shown in FIG. 10B) that may be moved, for example, from a stowed position to a deployed position, or vice versa, by automated means (e.g., through controlling the hinge assemblies).

The vehicle 700 may further include one or more user inputs 788. As non-limiting examples, the one or more user inputs 788 may include a display, a button, a dial, a microphone, or a combination thereof. The one or more user inputs 788 may be utilized to operate the one or more motors 786. In an exemplary operation, a touch input or gesture to a display, or touchscreen, of the one or more user inputs 788 provides an input to the controller 780. The one or more processors 782 may execute instructions stored on the memory 784, which results in instructions or commands to actuate the one or more motors 786.

While the one or more user inputs 788 are shown as being part of, or integrated with, the vehicle 700, the one or more user inputs 788 may be non-integrated user inputs (e.g., mobile wireless communication device, fob). In this regard, the vehicle 700 may further include wireless circuitry 790 designed to communicate (e.g., receive) wireless transmission, such as radio frequency (RF) communication, from a non-integrated user input. As non-limiting examples, the RF communication may include wireless circuitry 790 operating in accordance with protocol such as BLUETOOTH® or WI-FI®. When the selected user input of the one or more user inputs 788 is non-integrated with the vehicle, the wireless circuitry 790 may be used to receive wireless data from the user input.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An apparatus, comprising:
a panel configured to provide a receiving surface for one or more objects;
a carrier comprising a recess configured to receive the panel in a first position, the carrier comprising a guide; and
a bracket coupled to the panel, the bracket configured to move along the guide and transition the panel to a second position different from the first position.

2. The apparatus of claim 1, wherein in the second position, the panel is removed from the recess.

3. The apparatus of claim 2, wherein in the second position, the panel is rotated relative to the carrier.

4. The apparatus of claim 2, wherein in the second position, the panel is perpendicular with respect to the carrier.

5. The apparatus of claim 1, wherein:
the carrier is configured to secure within a gate body of a vehicle,
the panel, in the first position, is stowed in the gate body, and
the panel, in the second position, is deployed from the gate body.

6. The apparatus of claim 1, wherein the panel, in the second position, provides the receiving surface.

7. The apparatus of claim 1, further comprising a bushing coupled with the panel, wherein:
the carrier comprises a rail, and
the bushing is located in the rail.

8. The apparatus of claim 7, wherein the bushing is configured to move with the panel.

9. The apparatus of claim 7, wherein the panel is configured to rotate from the first position to the second position based on the bushing.

10. A gate for a vehicle, the gate comprising:
a gate body comprising an opening;
a carrier coupled with the gate body and positioned in the opening, the carrier comprising a rail;
a bushing located in the rail; and
a panel coupled with the bushing, wherein:
in a first position, the panel is positioned in the opening, and
in a second position, the panel is moved out the carrier and the opening and rotated relative to the gate body.

11. The gate of claim 10, wherein:
the bushing is configured to move along the rail, and
the panel is configured to rotate relative to the bushing.

12. The gate of claim 10, wherein:
the gate body comprises an edge, and
the panel, in the second position, is flush with the edge.

13. The gate of claim 10, further comprising an enclosure, wherein the enclosure is configured to:
occupy an opening of the gate body, and
move relative to the opening and into the gate body.

14. The gate of claim 13, wherein the enclosure comprises glass.

15. The gate of claim 10, wherein the panel, in the second position, provides a receiving surface for one or more objects.

16. The gate of claim 10, wherein:
the carrier comprises a recess, and
the panel, in the first position, is positioned in the recess.

17. A vehicle, comprising:
a vehicle body that defines a cabin; and
a gate configured to move relative to the vehicle body, the gate comprising:
a gate body comprising an opening;
a carrier coupled with the gate body and positioned in the opening, the carrier comprising a rail;
a bushing located in the rail; and
a panel coupled with the bushing, wherein:
in a first position, the panel is positioned in the opening, and
in a second position, the panel is moved out the carrier and the opening and rotated relative to the gate body.

18. The vehicle of claim 17, wherein the panel, in the second position, extends into the cabin.

19. The vehicle of claim 17, wherein:
the bushing is configured to move along the rail, and
the panel is configured to rotate relative to the bushing.

20. The vehicle of claim 17, wherein:
the gate body comprises an edge, and
the panel, in the second position, is flush with the edge.
